(19) United States
(12) Patent Application Publication
(10) Pub. No.: US 2023/0094520 A1
(43) Pub. Date: Mar. 30, 2023

(54) APPARATUS FOR CONTROLLING VEHICLE DISPLAY BASED ON APPROACH DIRECTION DETERMINATION USING PROXIMITY SENSOR

(71) Applicant: HYUNDAI MOBIS Co., Ltd., Seoul (KR)

(72) Inventors: Tae Hun KIM, Seongnam-si (KR); Sung Hyun PARK, Hwaseong-si (KR); Jun Seong SEO, Yongin-si (KR); Seung Hwan LEE, Hwaseong-si (KR)

(73) Assignee: HYUNDAI MOBIS Co., Ltd., Seoul (KR)

(21) Appl. No.: 17/898,863

(22) Filed: Aug. 30, 2022

(30) Foreign Application Priority Data
Sep. 15, 2021 (KR) 10-2021-0123495

(51) Int. Cl. B60K 35/00

(52) U.S. Cl. CPC B60K 35/00; B60K 2370/52; B60K 2370/115; B60K 2370/141; B60K 2370/197; B60K 2370/563; B60K 2370/1468

(57) ABSTRACT

An apparatus for determining an approach direction of a gesture of a vehicle occupant (a driver or a fellow passenger) by using a proximity sensor and controlling a vehicle display based on the approach direction determination. The apparatus includes an input unit to receive information on an approach direction in which an occupant’s hand in a vehicle moves to operate a vehicle function, a memory to store a program for controlling the vehicle display by using the information on the approach direction, and a processor to execute the program. The processor controls the vehicle display to perform different functions when an input is made to the same button based on information on a first approach direction in which a driver’s hand approaches from a driver seat side and information on a second approach direction in which a fellow passenger’s hand approaches from a passenger seat side.

### CROSS-REFERENCE TO RELATED APPLICATIONS

This application claims priority to and the benefit of Korean Patent Application No. 10-2021-0123495, filed on Sep. 15, 2021, the disclosures of which are incorporated herein by reference in their entirety.

### BACKGROUND

### 1. Technical Field

The present disclosure relates to an apparatus for determining an approach direction of a gesture of a vehicle occupant (a driver or a fellow passenger) by using a proximity sensor and controlling a vehicle display based on the approach direction determination.

### 2. Related Art

According to the related art, it is possible to operate functions in a vehicle (e.g., operate a navigation system, air conditioning setting, radio frequencies, sound volume, and the like) in response to a touch input signal made by an input onto a vehicle display screen and an input signal made by pushing a physical button.

However, the related art does not separately recognize and distinguish whether the driver’s hand approaches and operates the touch or physical button or whether the fellow passenger’s hand approaches and operates the touch or physical button.

That is, a preset function may only be operated in response to a touch input or physical button push input without considering a direction in which the driver or fellow passenger’s hand approaches. For this reason, there is a limitation in that it is impossible to provide a vehicle display control function that is performed by an approach of the driver or fellow passenger’s hand and conforms to the needs of each user.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

Various embodiments are directed to an apparatus that can use a proximity sensor and determine a direction in which a hand approaches to make a touch input or make an input by pushing a physical button and provides different human machine interfaces (HMIs) related to a function and screen depending on the determination result, thereby improving efficiency in approaching the function.

The present disclosure relates to an apparatus for determining an approach direction of a gesture of a vehicle occupant (a driver or a fellow passenger) by using a proximity sensor and controlling a vehicle display based on the approach direction determination.

In one general aspect, an apparatus for controlling a vehicle display based on approach direction determination using a proximity sensor includes: an input unit configured to receive information on an approach direction in which an occupant’s hand in a vehicle moves to operate a vehicle function; a memory configured to store a program for controlling the vehicle display by using the information on the approach direction; and a processor configured to execute the program. The processor is configured to control the vehicle display to perform different functions when an input is made to the same button based on information on a first approach direction in which a driver’s hand approaches from a driver seat side and information on a second approach direction in which a fellow passenger’s hand approaches from a passenger seat side.

The processor may be configured to display an operation guide, which is related to a function operable by a hard button, through the vehicle display based on the information on the approach direction made by determining whether a hand approaching the hard button is the driver’s hand or the fellow passenger’s hand.

The processor may be configured to determine a menu, which is activated among menu buttons displayed in a preset region of the vehicle display by using the information on the approach direction, and to provide an operation guide related to the menu.

The processor may be configured to recognize the connection state of the driver’s smartphone and the fellow passenger’s smartphone. When a function related to the cooperation of the smartphones is selected, the processor may be configured to control the contents playing on the driver’s smartphone or the fellow passenger’s smartphone to be displayed through the vehicle display by using the information on the approach direction.

When a smartphone, which operates in conjunction with the vehicle, is the driver’s smartphone and the fellow passenger’s hand intends to approach and perform the function of the smartphone that operates in conjunction with the vehicle, the processor may be configured to control the corresponding function not to operate.

When the fellow passenger’s hand approaches, the processor may be configured to control the vehicle display to separately display a menu that does not operate even when the menu is selected by the fellow passenger’s hand.

When a point of interest (POI) is clicked during a navigation guide, the processor may be configured to control the vehicle display to move to the POI, display information related to the POI based on the information on the first approach direction, and display the information on the POI in a screen region configured to be separately split from a route guide screen based on the information on the second approach direction.

In another general aspect, a method of controlling a vehicle display based on approach direction determination using a proximity sensor includes: (a) checking an approach direction in which an occupant’s hand in a vehicle moves to operate a vehicle function; and (b) controlling the vehicle display to perform different functions when an input is made to the same button based on information on a first approach direction in which a driver’s hand approaches from a driver seat side and information on a second approach direction in which a fellow passenger’s hand approaches from a passenger seat side.

Step (a) may include checking the approach direction on whether a hand approaching a hard button is the driver’s hand or the fellow passenger’s hand. Step (b) may include displaying an operation guide, which is related to a function operable by using the hard button, through the vehicle display based on the approach direction.

Step (b) may include determining a menu, which is activated among menu buttons displayed in a preset region of the vehicle display based on the approach direction, and providing an operation guide related to the menu.

Step (b) may include recognizing a connection state of the driver’s smartphone and the fellow passenger’s smartphone. When a function related to the cooperation of the smartphones is selected, step (b) may include controlling contents playing on the driver’s smartphone or the fellow passenger’s smartphone to be displayed through the vehicle display based on the approach direction.

When a smartphone, which operates in conjunction with the vehicle, is the driver’s smartphone and the fellow passenger’s hand intends to approach to perform the function of the smartphone that operates in conjunction with the vehicle, step (b) may include controlling the corresponding function not to operate.

When the fellow passenger’s hand approaches, step (b) may include controlling the vehicle display to separately display a menu that does not operate even when the menu is selected by the fellow passenger’s hand.

When a point of interest (POI) is clicked during a navigation guide, step (b) may include controlling the vehicle display to move to the POI, display information related to the POI based on the information on the first approach direction, and display the information on the POI in a screen region configured to be separately split from a route guide screen based on the information on the second approach direction.

According to the present disclosure, the function and screen are provided based on the direction in which the driver’s hand and the fellow passenger’s hand approach, which makes it possible for the driver’s hand and the fellow passenger’s hand to quickly approach the function that the driver and the fellow passenger intend to use.

According to the present disclosure, the direction in which the driver or fellow passenger’s hand approaches is determined, which makes it possible to provide the service by connecting the smartphone owned by the driver or the smartphone owned by the fellow passenger to a vehicle AVN.

According to the present disclosure, the direction in which the driver or fellow passenger’s hand approaches is determined, and whether the driver or fellow passenger’s hand may approach a particular function is determined for each user, which makes it possible to protect the privacy.

According to the present disclosure, during the process of operating the navigation screen, the screen is differently controlled depending on the direction in which the driver or fellow passenger’s hand approaches, and whether to consistently display the traveling route screen is determined, which makes it possible to support the driver so that the driver drives a vehicle while checking the traveling route without missing the traveling route.

The effects of the present disclosure are not limited to the above-mentioned effect, and other effects, which are not mentioned above, may be clearly understood by those skilled in the art from the following descriptions.

Other features and aspects will be apparent from the following detailed description, the drawings, and the claims.

### BRIEF DESCRIPTION OF THE DRAWINGS

FIG. 1 illustrates a system for controlling a vehicle display based on approach direction determination using a proximity sensor according to an embodiment of the present disclosure.

FIG. 2 illustrates different hard button operations made by an approach of a driver or an approach of a fellow passenger according to the embodiment of the present disclosure.

FIGS. 3 and 4 illustrate display touch button references according to the embodiment of the present disclosure.

FIG. 5 illustrates an operation guide according to the embodiment of the present disclosure.

FIG. 6 illustrates a cooperation between the driver’s smartphone and the fellow passenger’s smartphone according to the embodiment of the present disclosure.

FIGS. 7 and 8 illustrate a privacy mode according to the embodiment of the present disclosure.

FIG. 9 illustrates a navigation screen operation according to the embodiment of the present disclosure.

FIG. 10 illustrates an apparatus for controlling a vehicle display based on approach direction determination using a proximity sensor according to an embodiment of the present disclosure.

### DETAILED DESCRIPTION

The above-mentioned object, other objects, advantages, and features of the present disclosure and methods of achieving the objects, advantages, and features will be clear with reference to embodiments described in detail below together with the accompanying drawings.

However, the present disclosure is not limited to the embodiments disclosed herein but will be implemented in various forms. The following embodiments are merely provided to allow those skilled in the technical field to which the present disclosure pertains to easily understand the object, configuration, and effect of the present disclosure, and the scope of the present disclosure is defined by the disclosure disclosed in claims.

Meanwhile, the terms used in the present specification are for explaining the embodiments, not for limiting the present disclosure. Unless particularly stated otherwise in the present specification, a singular form also includes a plural form. The terms “comprise (include)” and/or “comprising (including)” used in the specification are intended to specify the presence of the mentioned constituent elements, steps, operations, and/or elements, but do not exclude the presence or addition of one or more other constituent elements, steps, operations, and/or elements.

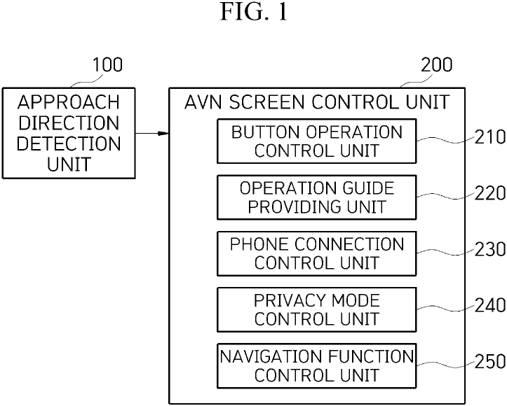

FIG. 1 illustrates a system for controlling a vehicle display based on approach direction determination using a proximity sensor according to an embodiment of the present disclosure.

The system for controlling a vehicle display based on approach direction determination using a proximity sensor according to the embodiment of the present disclosure includes: an approach direction detection unit 100 configured to detect an approach direction of a vehicle occupant’s hand by using a proximity sensor in a vehicle; and an AVN screen control unit 200 configured to perform AVN screen control based on the approach direction.

According to the embodiment of the present disclosure, it is possible to determine the approach direction of the occupant’s hand in the vehicle by using the proximity sensor. As another example, it is also possible to determine the approach direction of the occupant’s hand by capturing an image or by using an ultrasonic sensor, a non-contact haptic display, or the like.

The AVN screen control unit 200 includes: a button operation control unit 210 configured to differently control an operation of a hard button based on an approach direction; an operation guide providing unit 220 configured to change and provide information display in accordance with an approach for each detailed position and provide an operation guide in accordance with a keypad button operation during an approach to a keypad; a phone connection control unit 230 configured to recognize connection states of a smartphone owned by the driver and a smartphone owned by a fellow passenger and control connection between an AVN and the smartphone in accordance with an approach of the driver’s hand or an approach of the fellow passenger’s hand; a privacy mode control unit 240 configured to control an operation of a function of the smartphone connected to the AVN or an operation of a function of the AVN in accordance with the approach of the driver’s hand or the approach of the fellow passenger’s hand; and a navigation function control unit 250 configured to provide different screens when a point of interest (POI) in a map is clicked during a navigation guide in accordance with the approach of the driver’s hand or the approach of the fellow passenger’s hand.

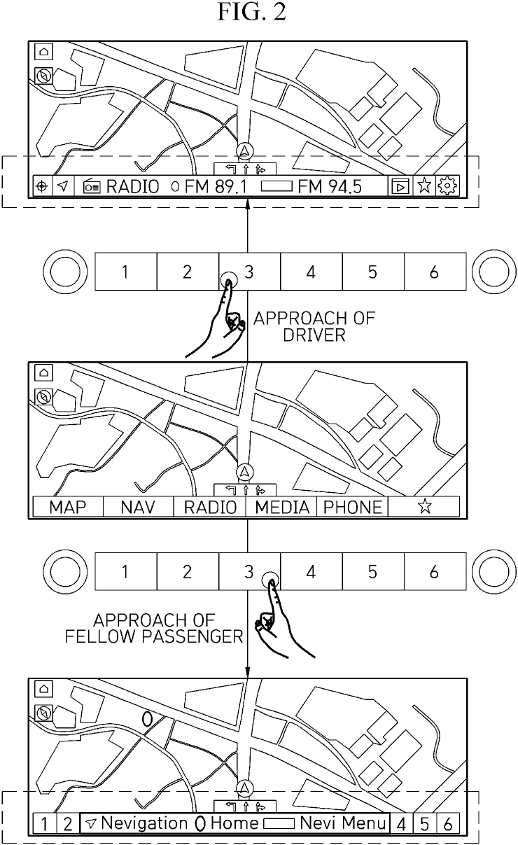

FIG. 2 illustrates a change in hard button operation in accordance with a direction in which the driver or fellow passenger approaches according to the embodiment of the present disclosure.

During the approach to each keypad, each keypad button is activated, and an operation guide is provided when a corresponding keypad button is pushed for a short time (▪) or pushed for a long time (—).

Referring to FIG. 2, for the same hard button a function made by the approach of the driver’s hand from the driver’s side and a function made by the approach of the fellow passenger’s hand from the fellow passenger’s side are different from each other.

For example, a screen related to radio function control is displayed at a lower end of the AVN screen when the driver’s hand approaches from the driver’s side, and a screen related to navigation control is displayed at the lower end of the AVN screen when the fellow passenger’s hand approaches from the fellow passenger’s side.

As the driver’s hand approaches, the operation guide is provided such that the frequency is adjusted to FM 89.1 MHz when the hard button is pushed for a short time (▪), and the frequency is adjusted to FM 94.5 MHz when the hard button is pushed for a long time (—).

As the fellow passenger’s hand approaches, the operation guide is provided such that a destination is set to Home when the hard button is pushed for a short time (▪), and a navigation menu is displayed when the hard button is pushed for a long time (—).

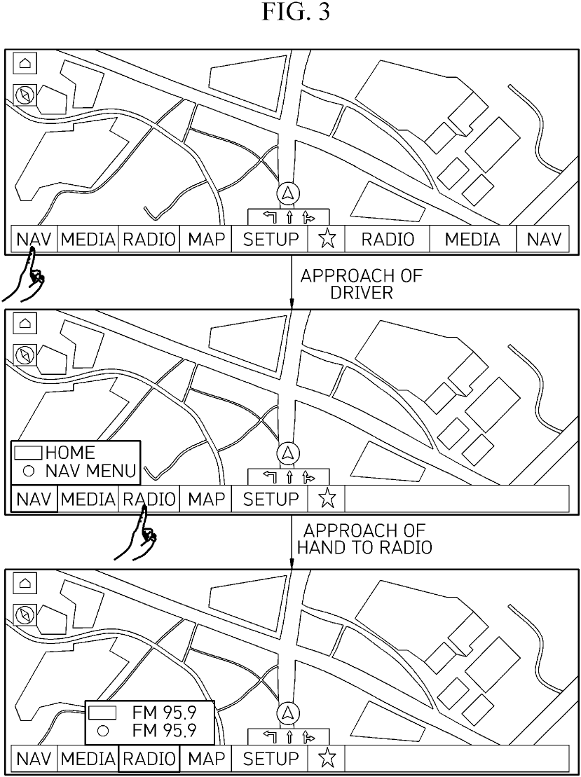

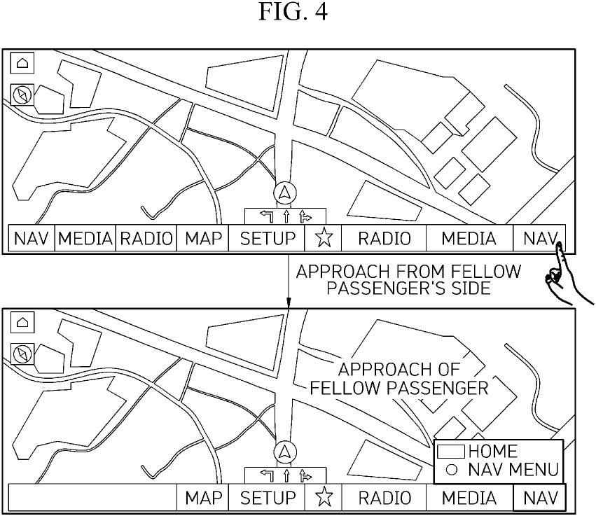

FIGS. 3 and 4 illustrate display touch button references according to the embodiment of the present disclosure.

According to the embodiment of the present disclosure, a detailed position is determined, whether the driver or fellow passenger’s hand approaches is determined, and the information display is changed in accordance with the approach and provided.

Referring to FIG. 3, when the approach of the driver’s hand to the navigation menu among menus displayed at the lower end of the AVN screen is detected, a navigation button is activated, and the operation guide is provided such that the destination is set to ‘Home’ when the navigation button is pushed for a short time (▪) during the touch input to the navigation button, and the navigation menu is displayed when the navigation button is pushed for a long time (—) during the touch input to the navigation button.

Referring to FIG. 3, when the approach of the driver’s hand to a radio menu among the menus displayed at the lower end of the AVN screen is detected, a radio button is activated, and the operation guide is provided such that the frequency is adjusted to FM 94.5 MHz when the radio button is pushed for a short time (▪) during the touch input to the radio button, and the frequency is adjusted to FM 95.9 MHz when the radio button is pushed for a long time (—) during the touch input to the radio button.

Referring to FIG. 4, when the approach of the fellow passenger’s hand to the navigation menu among the menus displayed at the lower end of the AVN screen is detected, the navigation button is activated, and the operation guide is provided such that the navigation menu is displayed when the navigation button is pushed for a short time (▪) during the touch input to the navigation button, and the destination is set to ‘Home’ when the navigation button is pushed for a long time (—) during the touch input to the navigation button.

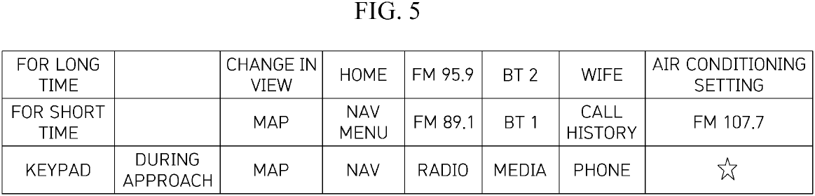

FIG. 5 illustrates the operation guide according to the embodiment of the present disclosure.

As illustrated in FIG. 5, during the approach to each keypad, each keypad button is activated, and the operation guide related to a case in which a corresponding keypad button is pushed for a short time (▪) or pushed for a long time (—) is provided.

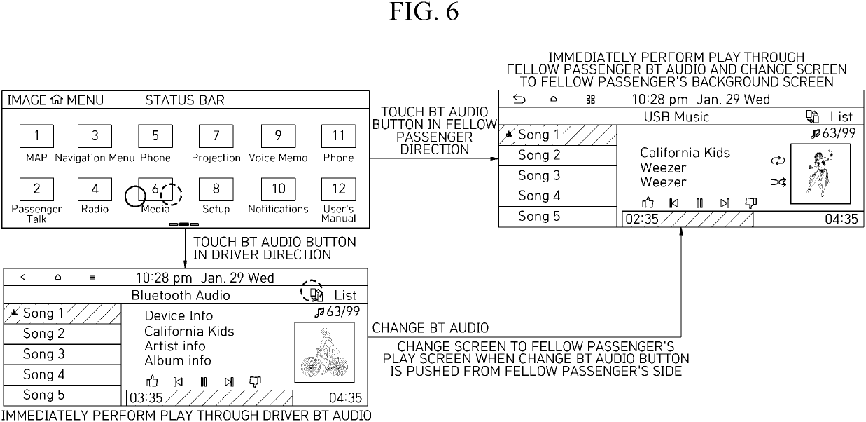

FIG. 6 illustrates a cooperation with the driver’s smartphone and the fellow passenger’s smartphone according to the embodiment of the present disclosure.

According to the embodiment of the present disclosure, the connection states of the driver’s smartphone and the fellow passenger’s smartphone are recognized, a proximity sensor is used to recognize that the driver or fellow passenger approaches and pushes a button, and a smartphone cooperation function is provided to conform to the user’s needs.

Referring to FIG. 6, it is assumed that the driver’s smartphone and the fellow passenger’s smartphone are connected to the AVN and two audio systems are respectively connected to the driver’s smartphone and the fellow passenger’s smartphone.

In a case in which only the driver is seated in the vehicle, the vehicle recognizes, as a registered phone, a smartphone owned by the driver.

In addition, when a smartphone is additionally registered in addition to the driver’s smartphone connected in advance, the audio system is connected, and the fellow passenger seated in the vehicle is recognized, the vehicle recognizes, as the additionally registered phone, a smartphone owned by the fellow passenger.

A button corresponding to menu 6 on the AVN screen is a media button, and when the driver’s hand approaches from the driver’s side and touches a Bluetooth audio button, a sound source of the driver’s smartphone is played through a driver’s Bluetooth audio system, and the AVN screen is changed to a driver’s background screen.

In this case, when a request to change the Bluetooth audio system is inputted, a sound source of the fellow passenger’s smartphone is played through a fellow passenger Bluetooth audio system, and the AVN screen is changed to a fellow passenger’s background screen.

In addition, when the fellow passenger’s hand approaches from the fellow passenger’s side and touches the Bluetooth audio button, a sound source of the fellow passenger’s smartphone is played through the fellow passenger’s Bluetooth audio system, and the AVN screen is changed to the fellow passenger’s background screen.

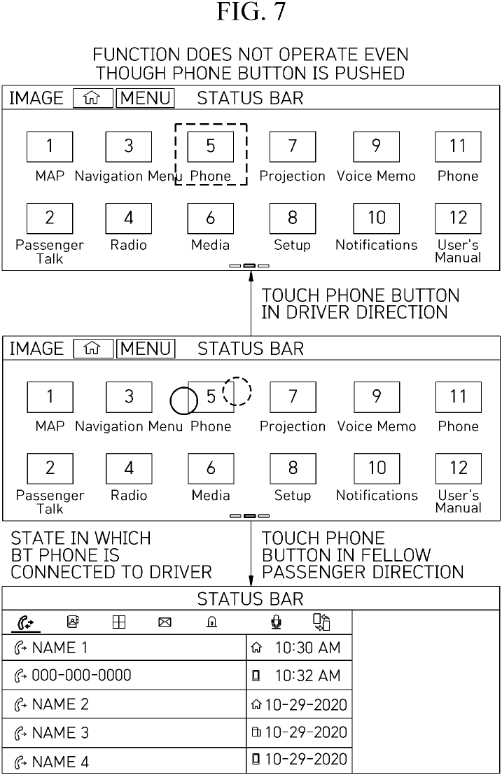

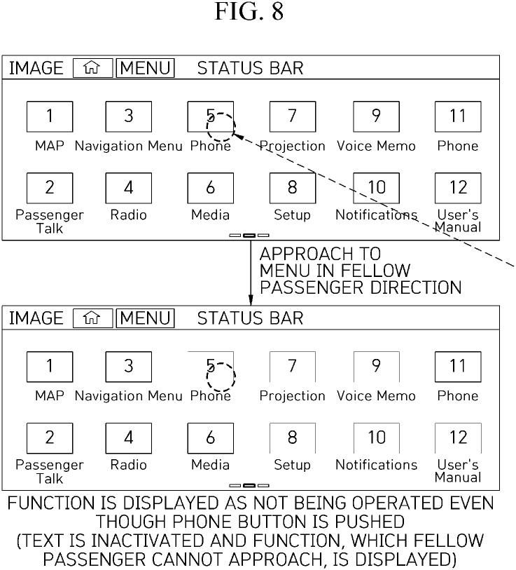

FIGS. 7 and 8 illustrate a privacy mode according to the embodiment of the present disclosure.

Referring to FIG. 7, it is assumed that menu 5 on the AVN screen is a phone button and the driver’s smartphone is connected to the vehicle AVN.

When the driver’s hand approaches from the driver’s side and applies a touch input to the phone button, a phone screen is displayed through the AVN screen.

When the fellow passenger’s hand approaches from the fellow passenger’s side and applies a touch input to the phone button, the phone screen is not displayed through the AVN screen (the phone function does not operate).

Referring to FIG. 8, when the fellow passenger’s hand approaches the AVN screen from the fellow passenger’s side, functions, which does not operate even though the fellow passenger’s hand applies the touch input, are displayed blurrily.

For example, the functions such as Phone of menu 5, Projection of menu 7, Setup of menu 8, Voice Memo of menu 9, Notification of menu 10, and Manual of menu 12 are displayed as not being operated even though the fellow passenger’s hand pushes corresponding buttons. Further, the text is inactivated, the function, which the fellow passenger cannot approach, is displayed, and the function, which the fellow passenger cannot approach, is eliminated from the screen.

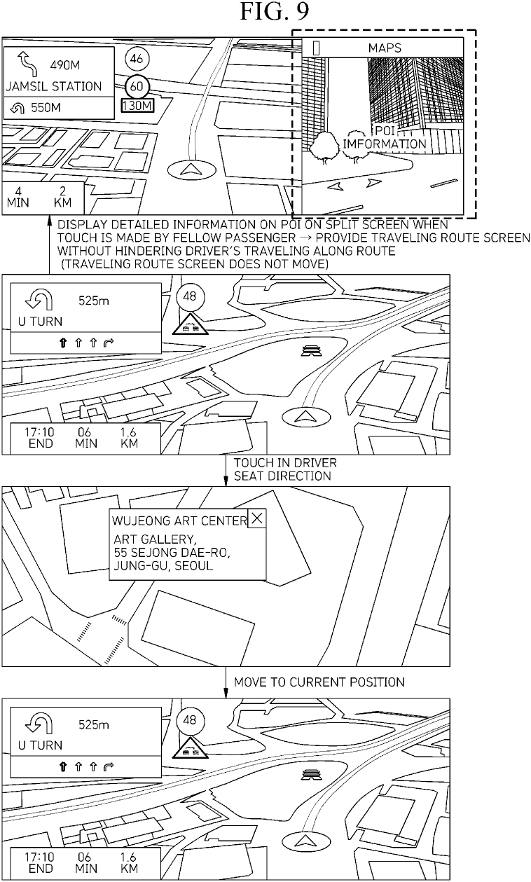

FIG. 9 illustrates a navigation screen operation according to the embodiment of the present disclosure.

When the driver’s hand approaches from a driver seat side and touches Wujeong Art Center as a point of interest (POI) on the AVN screen during the navigation guide, the AVN screen displays information on the POI while enlarging the corresponding POI. Next, when the movement to the current position is requested, the screen returns to a route information screen.

When the fellow passenger’s hand approaches from a passenger seat side and touches a POI on the AVN screen during the navigation guide, detailed information on the POI is displayed through separate split screens, and a traveling route screen is consistently provided without moving and hindering the driver’s traveling along the route.

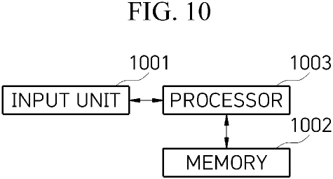

FIG. 10 illustrates an apparatus for controlling a vehicle display based on approach direction determination using a proximity sensor according to the embodiment of the present disclosure.

The apparatus for controlling a vehicle display based on approach direction determination using a proximity sensor according to the embodiment of the present disclosure includes: an input unit 1001 configured to receive information on an approach direction in which an occupant’s hand in a vehicle moves to operate a vehicle function; a memory 1002 configured to store a program for controlling the vehicle display by using the information on the approach direction; and a processor 1003 configured to execute the program. The processor 1003 controls the vehicle display to perform different functions when an input is made to the same button based on information on a first approach direction in which a driver’s hand approaches from a driver seat side and information on a second approach direction in which a fellow passenger’s hand approaches from a passenger seat side.

The processor 1003 displays an operation guide, which is related to a function operable by a hard button, through the vehicle display based on the information on the approach direction made by determining whether a hand approaching the hard button is the driver’s hand or the fellow passenger’s hand.

The processor 1003 determines a menu, which is activated among menu buttons displayed in a preset region of the vehicle display by using the information on the approach direction, and provides an operation guide related to the activated menu.

The processor 1003 recognizes the connection state of the driver’s smartphone and the fellow passenger’s smartphone. When the function related to the cooperation of the smartphones is selected, the processor 1003 controls the contents playing on the driver’s smartphone or the fellow passenger’s smartphone to be displayed through the vehicle display by using the information on the approach direction.

The processor 1003 controls the corresponding function not to operate when the smartphone, which operates in conjunction with the vehicle, is the driver’s smartphone and the fellow passenger’s hand intends to approach to perform a function of the smartphone that operates in conjunction with the vehicle.

When the fellow passenger’s hand approaches, the processor 1003 controls the vehicle display to separately display a menu that does not operate even though the menu is selected by the fellow passenger’s hand.

When a POI is clicked during the navigation guide, the processor 1003 controls the vehicle display to move to the POI, display information related to the POI based on the information on the first approach direction, and display the information on the POI in a screen region configured to be separately split from a route guide screen based on the information on the second approach direction.

Meanwhile, a method of controlling a vehicle display based on approach direction determination using a proximity sensor according to the embodiment of the present disclosure may be implemented by a computer system or recorded in a recording medium. The computer system may include one or more processors, a memory, a user input device, a data communication bus, a user output device, and a storage. The above-mentioned constituent elements perform data communication through the data communication bus.

The method of controlling a vehicle display based on approach direction determination using a proximity sensor according to the embodiment of the present disclosure includes: step (a) of checking an approach direction in which an occupant’s hand in a vehicle moves to operate a vehicle function; and step (b) of controlling the vehicle display to perform different functions when an input is made to the same button based on information on a first approach direction in which a driver’s hand approaches from a driver seat side and the information on a second approach direction in which a fellow passenger’s hand approaches from a passenger seat side.

Step (a) checks the approach direction on whether a hand approaching a hard button is the driver’s hand or the fellow passenger’s hand. Step (b) displays an operation guide, which is related to a function operable by using the hard button, through the vehicle display based on the approach direction.

Step (b) determines a menu, which is activated among menu buttons displayed in the preset region of the vehicle display based on the approach direction, and provides an operation guide related to the activated menu.

Step (b) recognizes a connection state of the driver’s smartphone and the fellow passenger’s smartphone. When the function related to the cooperation of the smartphones is selected, step (b) performs the contents playing on the driver’s smartphone or the fellow passenger’s smartphone to be displayed through the vehicle display based on the approach direction.

When a smartphone, which operates in conjunction with the vehicle, is the driver’s smartphone and the fellow passenger’s hand intends to approach to perform a function of the smartphone that operates in conjunction with the vehicle, step (b) controls the corresponding function not to operate.

When the fellow passenger’s hand approaches, step (b) controls the vehicle display to separately display a menu that does not operate even though the menu is selected by the fellow passenger’s hand.

When a POI is clicked during a navigation guide, step (b) controls the vehicle display to move to the POI, display information related to the POI based on the information on the first approach direction, and display the information on the POI in a screen region configured to be separately split from a route guide screen based on the information on the second approach direction.

The computer system may further include a network interface coupled to a network. The processor may be a central processing unit (CPU) or a semiconductor device that processes commands stored in the memory and/or the storage.

The memory and the storage may include volatile or non-volatile storage media having various shapes. Examples of the memory may include a read only memory (ROM) and a random-access memory (RAM).

Therefore, the method of controlling a vehicle display based on approach direction determination using a proximity sensor according to the embodiment of the present disclosure may be implemented as a method that may be executed by a computer. When the method of controlling a vehicle display based on approach direction determination using a proximity sensor according to the embodiment of the present disclosure is performed by a computer, computer-readable commands may perform the method of controlling a vehicle display based on approach direction determination using a proximity sensor according to the embodiment of the present disclosure.

Meanwhile, the method of controlling a vehicle display based on approach direction determination using a proximity sensor according to the embodiment of the present disclosure may be implemented as a computer-readable code in a computer-readable recording medium. Examples of the computer-readable recording medium includes all kinds of recording media for storing data readable by a computer system. Specific examples thereof may include a read only memory (ROM), a random-access memory (RAM), a magnetic tape, a magnetic disc, a flash memory, an optical data storage device, and the like. In addition, the computer-readable recording medium may be distributed to a computer system connected by a computer communication network and stored and executed as a computer-readable code in a distributed manner.

The present invention has been described above with respect to embodiments thereof. Those skilled in the art should understand that various changes in form and details may be made herein without departing from the essential characteristics of the present invention. Therefore, the embodiments described herein should be considered from an illustrative aspect rather than from a restrictive aspect. The scope of the present invention should be defined not by the detailed description but by the appended claims, and all differences falling within a scope equivalent to the claims should be construed as being encompassed by the present invention.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. An apparatus for controlling a vehicle display based on approach direction determination using a proximity sensor, the apparatus comprising:
an input unit configured to receive information on an approach direction in which an occupant’s hand in a vehicle moves to operate a vehicle function;
a memory configured to store a program for controlling the vehicle display by using the information on the approach direction; and
a processor configured to execute the program,
wherein the processor is configured to control the vehicle display to perform different functions when an input is made to the same button based on information on a first approach direction in which a driver’s hand approaches from a driver seat side and information on a second approach direction in which a fellow passenger’s hand approaches from a passenger seat side.

2. The apparatus of claim 1, wherein the processor is configured to display an operation guide, which is related to a function operable by a hard button, through the vehicle display based on the information on the approach direction made by determining whether a hand approaching the hard button is the driver’s hand or the fellow passenger’s hand.

3. The apparatus of claim 1, wherein the processor is configured to determine a menu, which is activated among menu buttons displayed in a preset region of the vehicle display by using the information on the approach direction, and to provide an operation guide related to the menu.

4. The apparatus of claim 1, wherein the processor is configured to recognize a connection state of the driver’s smartphone and the fellow passenger’s smartphone, and when a function related to cooperation of smartphones is selected, the processor is configured to control contents playing on the driver’s smartphone or the fellow passenger’s smartphone to be displayed through the vehicle display by using the information on the approach direction.

5. The apparatus of claim 1, wherein, when a smartphone, which operates in conjunction with the vehicle, is the driver’s smartphone and the fellow passenger’s hand intends to approach to perform a function of the smartphone that operates in conjunction with the vehicle, the processor is configured to control the corresponding function not to operate.

6. The apparatus of claim 5, wherein when the fellow passenger’s hand approaches, the processor is configured to control the vehicle display to separately display a menu that does not operate even when the menu is selected by the fellow passenger’s hand.

7. The apparatus of claim 1, wherein when a point of interest (POI) is clicked during a navigation guide, the processor is configured to control the vehicle display to move the POI, display information on the POI based on the information on the first approach direction, and display the information on the POI in a screen region configured to be separately split from a route guide screen based on the information on the second approach direction.

8. A method of controlling a vehicle display based on approach direction determination using a proximity sensor, the method comprising:
(a) checking an approach direction in which an occupant’s hand in a vehicle moves to operate a vehicle function; and
(b) controlling the vehicle display to perform different functions when an input is made to the same button based on information on a first approach direction in which a driver’s hand approaches from a driver seat side and information on a second approach direction in which a fellow passenger’s hand approaches from a passenger seat side.

9. The method of claim 8, wherein (a) includes checking the approach direction on whether a hand approaching a hard button is the driver’s hand or the fellow passenger’s hand, and (b) includes displaying an operation guide, which is related to a function operable by the hard button, through the vehicle display based on the approach direction.

10. The method of claim 8, wherein (b) includes determining a menu, which is activated among menu buttons displayed in a preset region of the vehicle display based on the approach direction, and providing an operation guide related to the menu.

11. The method of claim 8, wherein (b) includes recognizing a connection state of the driver’s smartphone and the fellow passenger’s smartphone, and when a function related to cooperation of smartphones is selected, and controlling contents playing on the driver’s smartphone or the fellow passenger’s smartphone to be displayed through the vehicle display based on the approach direction.

12. The method of claim 8, wherein, when a smartphone, which operates in conjunction with the vehicle, is the driver’s smartphone and the fellow passenger’s hand intends to approach to perform a function of the smartphone that operates in conjunction with the vehicle, (b) includes controlling the corresponding function not to operate.

13. The method of claim 12, wherein, when the fellow passenger’s hand approaches, (b) includes controlling the vehicle display to separately display a menu that does not operate even when the menu is selected by the fellow passenger’s hand.

14. The method of claim 8, wherein, when a point of interest (POI) is clicked during a navigation guide, (b) includes controlling the vehicle display to move the POI, displaying information on the POI based on the information on the first approach direction, and displaying the information on the POI in a screen region configured to be separately split from a route guide screen based on the information on the second approach direction.
